(19) United States
(12) Patent Application Publication
(10) Pub. No.: US 2025/0074201 A1
(43) Pub. Date: Mar. 6, 2025

(54) POWER SUPPLY FOR A RAIL VEHICLE, HAVING A TRACTION BATTERY

(71) Applicant: Siemens Mobility GmbH, München (DE)

(72) Inventors: Maik Dittrich, Erlangen (DE); Bernhard Höscheler, Erlangen (DE)

(21) Appl. No.: 18/293,012

(22) PCT Filed: Jan. 17, 2022
(86) PCT No.: PCT/EP2022/050895

§ 371 Date: Jan. 29, 2024

(30) Foreign Application Priority Data
Jul. 29, 2021 (DE) 10 2021 208 251.3

(51) Int. Cl. B60L 9/04; B60L 5/18

(52) U.S. Cl. CPC B60L 9/04; B60L 5/18; B60L 2200/26; B60L 2210/42

(57) ABSTRACT

A power supply device for a rail vehicle has a traction battery, a traction intermediate circuit, an on-board network, a bidirectional charging device, which is connected between the traction battery and the on-board network, and a first switching unit between the traction battery and the traction intermediate circuit for switching between a charging operation and a discharging operation of the traction battery. There is also described a power supply provision device, a method for discharging a traction battery of a power supply device, a method for charging a traction accumulator of a power supply device, and a rail vehicle.

The invention relates to a power supply device for a rail vehicle. The invention also relates to a power supply provision method. The invention additionally relates to a method for discharging a traction accumulator of a power supply device according to the invention. In addition, the invention relates to a method for charging a traction accumulator of a power supply device according to the invention. The invention moreover relates to a rail vehicle.

Only a little more than 60% of the rail network in Germany is electrified. Up until now, diesel-driven shunting locomotives, which are not particularly environmentally friendly and also entail additional costs, have frequently been used for operation on non-electrified rail sections, in particular for operation over the last mile. In order to save on shunting locomotives, consideration is given to using rail vehicles equipped with accumulators. However, installation or retrofitting of accumulators required for this purpose, also referred to as traction accumulators or traction batteries below, is extremely complicated, and therefore there is a need for a simplified circuit topology of a system of this kind. One economically effective solution could be equipping existing electric rail vehicles with relatively small additional traction batteries, that is to say ones which store a relatively small amount of energy and are used only when a rail vehicle is traveling a relatively short distance without a railway power network supply, such as when traveling over the last mile or during emergency travel to the next station in the event of a power failure in the railway power network for example. In the case of retrofitting of this kind, it is desirable to modify the rail vehicle as simply as possible and with as little expenditure as possible.

An electrified rail vehicle with a three-phase drive has what is known as a traction intermediate circuit, which is connected between the high-voltage supply from the railway power network and the three-phase drive or a traction unit operated with three-phase current. A traction intermediate circuit of this kind usually has a DC voltage of 2 to 4 kV (kV=kilovolt). However, the load-dependent terminal voltage of a traction battery is usually considerably lower, typically <1 kV. In order to supply the traction battery with a constant electrical voltage, a voltage-setting member is usually connected between the traction intermediate circuit and the traction battery. This DC/DC converter, as it is known, has to be designed for the full discharge power of a traction battery and is therefore relatively costly to manufacture, and it additionally has a high weight and an additional installation volume.

If the traction battery is intended to be charged via the three-phase power supply system, an additional rectifier has to be used in order to supply a suitable DC voltage to the input end of the DC/DC converter, via which the traction battery is intended to be charged. As an alternative, an on-board charger can also be installed in addition to or parallel to the DC/DC converter, this charger converting three-phase current into direct current in order to charge the traction battery.

In order to supply the secondary assemblies or auxiliary assemblies of a rail vehicle via the three-phase on-board electrical system, what is known as a standard auxiliary converter or on-board electrical system converter is required, this converting the direct current of the traction intermediate circuit with a relatively high electric voltage of 2 to 4 kV into three-phase current with a low electric voltage, for example 400 volts, and a suitable on-board electrical system frequency, so that secondary assemblies with three-phase asynchronous motors can be operated using the three-phase on-board electrical system. In the case of a low on-board electrical system load in the three-phase on-board electrical system, as typically occurs during operation for “the last mile” or emergency operation, the standard auxiliary converter runs with a low degree of efficiency since it is designed for a very high on-board electrical system load. Therefore, the supply of power to the fixed-frequency on-board electrical system during battery operation is efficient and the achievable range on the basis of the traction battery is reduced on account of the reduced degree of efficiency. In this case, a standard auxiliary converter is intended to be interpreted as an auxiliary converter with a construction and a design as are customary in conventional electrified rail vehicles.

EP 3 744 564 A1 describes an emergency traction system of a multiple-unit train. The emergency traction system has a bidirectional voltage converter, which is connected between a traction converter and an accumulator.

EP 2 230 123 A2 describes a stationary charging system, which is arranged on a rail section between two railway stations. The stationary charging system is connected to a commercial 440 kV three-phase line and is designed to supply electric charging current to a battery-operated rail vehicle.

CN 113 043 868 A describes an emergency traction system of a train. The emergency traction system has a bidirectional voltage converter, which is connected between a traction converter and an accumulator.

EP 2 599 656 A1 describes a drive control device for an electrically operated rail vehicle. The drive control device has switching elements with which a choice can be made between accumulator operation and operation via a DC network.

The object is therefore to realize a battery-fed power supply of a rail vehicle, in particular for battery operation over short distances, in a more resource-saving and more energy-saving manner than is the case with conventional solutions.

This object is achieved by a power supply device for a rail vehicle as claimed in patent claim 1, a power supply provision method as claimed in patent claim 7, a method for discharging a traction accumulator of a power supply device according to the invention as claimed in patent claim 8, a method for charging a traction accumulator of a power supply device according to the invention as claimed in patent claim 10, and a rail vehicle as claimed in patent claim 12.

The power supply device according to the invention for a rail vehicle has a traction accumulator. A traction accumulator is to be understood to mean a rechargeable electrical energy store which, in conjunction with the power supply device according to the invention, is used to supply power to traction units and preferably to the other electrical functional units of a rail vehicle independently of the power supply system. A traction accumulator is designed to provide high electrical power over a relatively long period of time for traction of a rail vehicle. A traction accumulator of this kind therefore has a large number of accumulator cells interconnected in parallel and in series and is designed as a high-voltage battery and for providing high electric currents in order to be able to provide enough power for traction of the rail vehicle. Electrical voltages of 400 volts to 1000 volts are customary battery rated voltages here in order to be able to drive heavy vehicles, such as rail vehicles for example. A traction accumulator usually also has what is known as a battery management system, with which overloading of individual cells when drawing energy is avoided. The traction units comprise electric motors for driving the drive wheels of the rail vehicle. For the purpose of supplying electric current with a suitable electrical voltage to the traction the power supply device according to the invention comprises a traction intermediate circuit. A traction intermediate circuit of this kind is part of what is known as a locomotive converter, which performs current/voltage conversion between the current of the railway power network and the assemblies of the rail vehicle. The electric motors of the traction units are usually operated using three-phase current, while the railway current is drawn from the railway power network as alternating current with a high electrical voltage, for example 15 kV or 25 kV.

In addition to the traction units, a rail vehicle further comprises a large number of different electrically operated auxiliary units, which are integrated into what is known as an on-board electrical system, which is likewise part of the power supply device according to the invention. An on-board electrical system of this kind usually provides three-phase current with an electrical voltage that is relatively low compared to the traction intermediate circuit, for example 400 V (V=volts). If the energy is provided to the on-board electrical system via the railway power network, the railway current is initially transformed into direct current of the traction intermediate circuit with an electrical voltage of 2 to 4 kV. In addition to the traction intermediate circuit, the abovementioned locomotive converter also comprises, amongst other things, what is known as an auxiliary converter. The auxiliary converter is designed to convert the direct current of the traction intermediate circuit into the type of current of the on-board electrical system, preferably three-phase current. In addition, an auxiliary transformer, which matches the electrical voltage of the three-phase current generated by the auxiliary converter to the low electrical voltage of the on-board electrical system, is also usually connected between the converter and the on-board electrical system.

The power supply device according to the invention then has, unlike conventional power supply devices of rail vehicles, a bidirectional charger, which is connected between the accumulator and the on-board electrical system. The bidirectional charger has two different interfaces. A first interface is electrically connected to the accumulator, receives direct current from the accumulator during discharge operation and outputs direct current to the accumulator during charging operation. Charging operation is intended to be understood to mean increasing the amount of electrical energy that is stored by the traction accumulator using an external energy source. Discharge operation is intended to be understood to mean outputting electrical energy that is stored in the traction battery to the outside.

A second interface is electrically connected to the on-board electrical system and, during discharging operation, also referred to as battery operation, outputs three-phase current with a lower electrical voltage compared to the electrical voltage of the railway power network or of the traction intermediate circuit, for example 400 V, to the on-board electrical system and receives three-phase current from the on-board electrical system during charging operation. In order to be able to perceive the charging/discharging function, the bidirectional charger has a converter unit, preferably comprising a converter/active rectifier and possibly a DC/DC converter, for converting on-board electrical system current into charging current, that is to say direct current, of the accumulator, and vice versa. The converter unit is preferably designed to convert the electric current of the on-board electrical system, preferably three-phase current, into direct current, and vice versa. The accumulator can provide the on-board electrical system with the required on-board electrical system current by means of the converter unit during discharging operation. During charging operation, the accumulator can be charged with direct current via the on-board electrical system. Since the on-board electrical system is both electrically connected to the traction intermediate circuit and usually has a connection for what is known as an external feed, it allows the bidirectional charger to electrically charge the traction accumulator via a customary external feed both during railway power network operation, for example during travel, and also when stationary, for example in a railway depot, without additional charging paths or interfaces.

In order that the traction accumulator can supply electrical energy to the traction unit, which is electrically connected to the traction intermediate circuit, during discharge operation, the power supply device according to the invention has a first switch unit between the accumulator and the traction intermediate circuit for switching over between charging operation and discharging operation of the traction accumulator. The first switch unit is therefore designed to electrically directly connect the traction accumulator to the traction intermediate circuit during discharging operation and to electrically disconnect the traction accumulator from the traction intermediate circuit during charging operation. The omission of the conventionally used DC/DC converter between the traction accumulator and the traction intermediate circuit is made possible owing to there being a relatively low requirement for charging power for the traction accumulator since the traction accumulator is mainly used for emergency travel and operation over the last mile. The traction accumulator is charged with a low charging power indirectly via the on-board electrical system and the bidirectional charger.

In addition, the power supply device according to the invention also comprises a second switch unit between the on-board electrical system and the traction intermediate circuit, which second switch unit is designed to switch off for discharging operation and to switch on for charging operation by means of an external railway power supply.

An additional DC/DC converter between the traction accumulator and the traction intermediate circuit, as is usually conventional, is advantageously not required. This situation is associated with the following advantages: during discharging operation, energy transmission losses are reduced. In addition, expenditure on and costs of the DC/DC converter that is not required are eliminated. Furthermore, weight and installation space are saved owing to the component that has been omitted. Moreover, an additional charger between the railway power network and the DC/DC converter or possibly an additional rectifier to the DC/DC converter is not required for charging operation for charging via an external feed or the on-board electrical system. The traction accumulator can advantageously be charged by the on-board electrical system via an external feed or via the railway power network. Therefore, a versatile power supply device, which is of relatively simple construction and can be readily retrofitted, for a rail vehicle is provided.

The second switch unit serves to establish an electrical connection between the traction intermediate circuit and the on-board electrical system via the auxiliary converter, and to interrupt this connection. The electrical connection is required for operating the on-board electrical system via the railway power network and charging the traction accumulator from the railway power network. During such charging operation, charging is performed from the railway power network via the traction intermediate circuit, the on-board electrical system and the bidirectional charger. Specifically, the charging path can comprise a current path via a pantograph, a main transformer, a four-quadrant chopper, the traction intermediate circuit, an auxiliary converter, an auxiliary transformer, the second switch unit, the on-board electrical system and the bidirectional charger. In this way, it is possible to charge the traction accumulator by an external railway power supply via the traction intermediate circuit and the on-board electrical system. An additional DC/DC converter between the traction accumulator and the traction intermediate circuit is not required for charging operation.

In the power supply provision method according to the invention, a bidirectional charger is connected between a traction accumulator and an on-board electrical system of a rail vehicle. As already mentioned, the traction accumulator can be electrically charged owing to the bidirectional function of the charger via a customary external feed both during railway power network operation, for example during travel, and also when stationary, for example in a railway depot, without additional charging paths or interfaces.

In addition, an auxiliary transformer is connected between the traction intermediate circuit, which is operated with an electrical voltage of 2 to 4 KV during network operation, and the on-board electrical system.

Furthermore, a first switch unit is provided between the traction accumulator and a traction intermediate circuit of the rail vehicle for switching over between charging operation and discharging operation of the accumulator. As already mentioned, the first switch unit serves to electrically directly connect the traction accumulator to the traction intermediate circuit during discharging operation and to electrically disconnect the traction battery from the traction intermediate circuit during charging operation.

A second switch unit is also provided between the on-board electrical system and the traction intermediate circuit, which second switch unit is designed to switch off for discharging operation and to switch on for charging operation by means of an external railway power supply.

An additional DC/DC converter between the traction accumulator and the traction intermediate circuit, as is usually conventional, is advantageously not required. Furthermore, an additional charger between the railway power network and the conventionally used DC/DC converter or possibly an additional rectifier to the conventionally used DC/DC converter for charging via an external feed or the on-board electrical system is not required for charging operation since the tasks of the omitted components are taken over by the bidirectional charger and the traction accumulator is charged via the on-board electrical system and the bidirectional charger. Charging of the traction accumulator even with the rail vehicle deactivated, in the case of which the locomotive converter, which comprises the traction intermediate circuit, is switched off, is advantageously also possible without additional expenditure owing to the use of the bidirectional charger with the locomotive converter being bypassed.

In the method according to the invention for discharging a traction accumulator of a power supply device according to the invention, the traction accumulator is electrically connected to the traction intermediate circuit of the rail vehicle by closing a switch of the first switch unit of the power supply device according to the invention. Then, via the current path produced in this way, electrical energy of the traction accumulator is transmitted to a traction unit of the rail vehicle via the traction intermediate circuit. Furthermore, the traction intermediate circuit is decoupled from the on-board electrical system via a switch of the second switch unit. In addition, electrical energy of the traction accumulator is transmitted to the on-board electrical system of the rail vehicle via the bidirectional charger of the power supply device according to the invention. Advantageously, both the traction intermediate circuit and the functional units connected to it as well as the on-board electrical system can be supplied with electrical energy via the traction accumulator. The supply of power to the on-board electrical system by the traction accumulator via the discharge path with the bidirectional charger can also be used for supplying power to a climate-control device for maintaining an expedient temperature range for the traction accumulator during a shut-down process of the rail vehicle in order to activate emergency climate control of the traction accumulator. This emergency power supply can be used, for example, to bridge a period time until an external feed takes over the supply of power to the on-board electrical system and thus also the supply of energy to the climate-control device.

In the method according to the invention for charging a traction accumulator of a power supply device according to the invention, the traction accumulator is charged via a series circuit comprising the on-board electrical system, the bidirectional charger and the traction accumulator. An additional charger between the railway power network and the conventionally used DC/DC converter or possibly an additional rectifier to the conventionally used DC/DC converter is advantageously not required for charging operation via an external feed or the on-board electrical system.

The rail vehicle according to the invention comprises a railway power network supply unit, preferably a pantograph. A railway power network supply unit of this kind forms an electrical connection between the railway power network and the rail vehicle during normal operation. Furthermore, the rail vehicle according to the invention comprises a traction unit, an auxiliary unit which can be supplied with electric current via an on-board electrical system, and a power supply device according to the invention for alternative supply of electric current to the traction unit and the auxiliary unit when supply via the railway power network is not possible or is not intended. An auxiliary unit is required for secondary operation of the rail vehicle, that is to say is not directly involved in traction of the rail vehicle. The rail vehicle according to the invention shares the advantages of the power supply device according to the invention.

The dependent claims and the subsequent description each contain particularly advantageous refinements and developments of the invention. Here, in particular, the claims of one claim category can also be developed in a manner analogous to the dependent claims of another claim category and the parts of the description pertaining thereto. In addition, the various features of different exemplary embodiments and claims can also be combined to form new exemplary embodiments within the scope of the invention.

In one variant of the power supply device according to the invention, the on-board electrical system comprises a three-phase on-board electrical system and the bidirectional charger comprises a current/voltage converting unit for current/voltage conversion between a DC voltage of the accumulator and a polyphase voltage of the on-board electrical system. The three-phase loads using the three-phase current of the on-board electrical system, such as power supply units or asynchronous motors with squirrel-cage rotors, can advantageously also be operated during battery operation. In comparison to devices operated with direct current, these three-phase loads have lower acquisition costs and maintenance costs, a lower mass, a lower space requirement and are more robust. If the network voltage is based on the customary voltage level of a low-voltage network, that is to say 230/400 V for example, commercially available electrical devices can thus be used.

In one variant of the power supply device according to the invention, the on-board electrical system comprises a feed interface for an on-board electrical system external feed. An on-board electrical system external feed of this kind can be performed, for example, in a depot or railway maintenance shed. The traction accumulator of the rail vehicle can be charged in this way, even if the rail vehicle is disconnected from the railway power network. The feed interface is usually in the form of a three-phase interface. As an alternative, single-phase charging operation with a correspondingly lower charging power is also possible.

The power supply device according to the invention particularly preferably comprises a regulating unit for regulating the charging power of the bidirectional charger to a remaining power reserve in the on-board electrical system during charging operation. Regulation of this kind can be performed as power regulation on the on-board electrical system-side input of the bidirectional charger depending on an actual power of the auxiliary transformer. The regulation information can be transmitted via a data line, preferably a CAN bus bypass line, by means of a controller. Only the unrequired portion of the energy flowing to the on-board electrical system is advantageously drawn from the on-board electrical system, so that all auxiliary units of the on-board electrical system are supplied with enough electrical energy. Therefore, flexible charging operation which is matched to the energy requirement of the on-board electrical system is possible. The on-board electrical system supply of the standard vehicle without battery equipment does not have to be increased for the charging power now arriving. In particular, the power of the auxiliary converter does not have to be increased depending on the consumption by the on-board electrical system for charging operation since the charging power is matched to the consumption by the on-board electrical system. A corresponding modification to the auxiliary converter when retrofitting a traction accumulator to a rail vehicle is therefore not required when equipping the rail vehicle with a power supply device according to the invention. Therefore, the situation of the battery equipment influencing the expenditure on resources and thus the costs of producing the standard rail vehicle without a battery equipment can be avoided.

In one variant of the power supply device according to the invention, the power supply device, preferably the locomotive converter of the power supply device, for supplying power to the on-board electrical system via an external railway power supply has an auxiliary converter, which can be electrically connected to the on-board electrical system via the second switch unit. As already briefly mentioned, the auxiliary converter converts the DC voltage in the traction intermediate circuit into another type of voltage, preferably a three-phase voltage of the on-board electrical system. The on-board electrical system can be supplied with electrical energy from the railway power network owing to this voltage conversion. It is also possible to charge the traction accumulator via the on-board electrical system and the bidirectional charger in this way. As already mentioned, the electrical connection between the auxiliary converter and the on-board electrical system is established by the second switch unit.

During discharging operation, it may be expedient to disconnect the traction intermediate circuit or the locomotive converter, which comprises the traction intermediate circuit, from the on-board electrical system. In particular when only very little load is present in the on-board electrical system, an auxiliary converter designed as a standard auxiliary converter can have a low degree of efficiency, so that the current path via the auxiliary converter is interrupted more effectively during discharging operation. The disconnection is preferably performed by switching off a switch of the abovementioned second switch unit between the on-board electrical system and the traction intermediate circuit. In this case, the on-board electrical system is advantageously supplied with electrical energy via the bidirectional charger with little loss. Therefore, the range of the rail vehicle is advantageously increased in comparison to supply of power to the on-board electrical system via the auxiliary converter or reduces the total energy consumption per unit time. On account of the low traction intermediate circuit voltage during battery operation, the maximum possible on-board electrical system voltage is limited by means of the standard auxiliary converter to a lower electrical voltage than during rated operation, that is to say during operation via the railway power network, and this would render the on-board electrical system usable to only a limited extent. This problem can likewise be solved by the bidirectional charger. Furthermore, an auxiliary operating converter standard auxiliary converter already used in conventional rail vehicles without battery equipment or standard auxiliary converter can be retained when the rail vehicle is retrofitted with a traction battery, as a result of which resources and expenditure on modification can be saved.

As an alternative, the auxiliary converter of the traction intermediate circuit can also be designed to be connectable in parallel to the bidirectional charger during discharging operation. In this variant, the auxiliary converter of the traction intermediate circuit serves as an additional auxiliary converter for a second on-board electrical system, which is disconnected from the first on-board electrical system. However, on account of the low traction intermediate circuit voltage during battery operation, the maximum possible on-board electrical system voltage is limited via the auxiliary converter of the traction intermediate circuit to a lower electrical voltage than during rated operation. Parallel connection can be performed by switching on the switch of the second switch unit between the on-board electrical system and the traction intermediate circuit.

In one variant of the method according to the invention for discharging a traction accumulator of a power supply device of a rail vehicle, the traction intermediate circuit is decoupled from the on-board electrical system via a switch of the second switch unit. As already mentioned, a greater degree of efficiency can be achieved during discharging operation when the auxiliary converter is electrically disconnected from the on-board electrical system during discharging operation, and therefore the range of the rail vehicle can be increased during battery operation or discharging operation. This gain in efficiency is achieved particularly when the bidirectional charger is designed in a manner matched to the electrical discharging/charging voltage of the traction accumulator. On account of this matching, the bidirectional charger can readily convert the discharging voltage of the traction accumulator into the on-board electrical system voltage. A standard auxiliary converter between the traction intermediate circuit and the on-board electrical system with a standard transmission ratio in the auxiliary transformer however does not manage to deliver the required on-board electrical system voltage when the discharging voltage of the traction accumulator is applied and with maximum modulation. On account of the discharge path, bypassing the standard auxiliary converter, to the on-board electrical system via the bidirectional charger, the standard auxiliary converter, which delivers the current for the on-board electrical system via the railway power network during operation, can be retained, so that the expenditure on modifying an electrical standard rail vehicle is limited.

In one variant of the method according to the invention for charging a traction accumulator of a power supply device, the traction accumulator is charged via an external railway power supply, which is electrically coupled to the series circuit comprising the on-board electrical system, the bidirectional charger and the traction accumulator via the traction intermediate circuit and a second switch unit between the on-board electrical system and the traction intermediate circuit. The excess portion of the railway current provided, which is not required by the loads, in particular a traction unit connected to the traction intermediate circuit and the on-board electrical system, can be used to charge the traction accumulator during normal operation, that is to say network operation of the rail vehicle, for example during travel.

The invention will be explained once again in more detail below using exemplary embodiments with reference to the appended figures, in which:

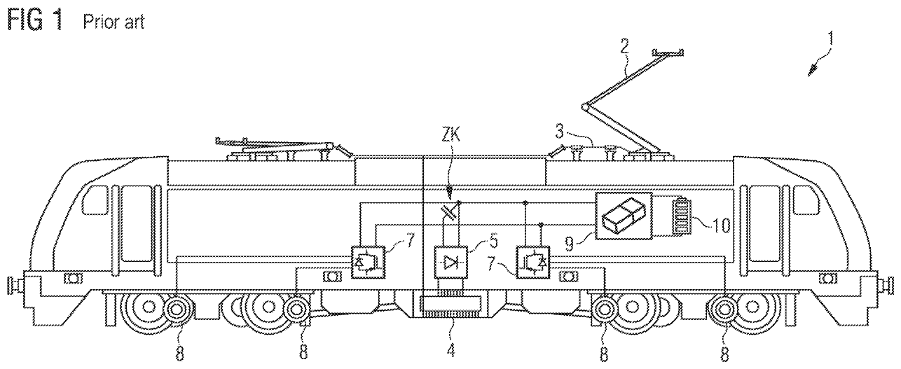

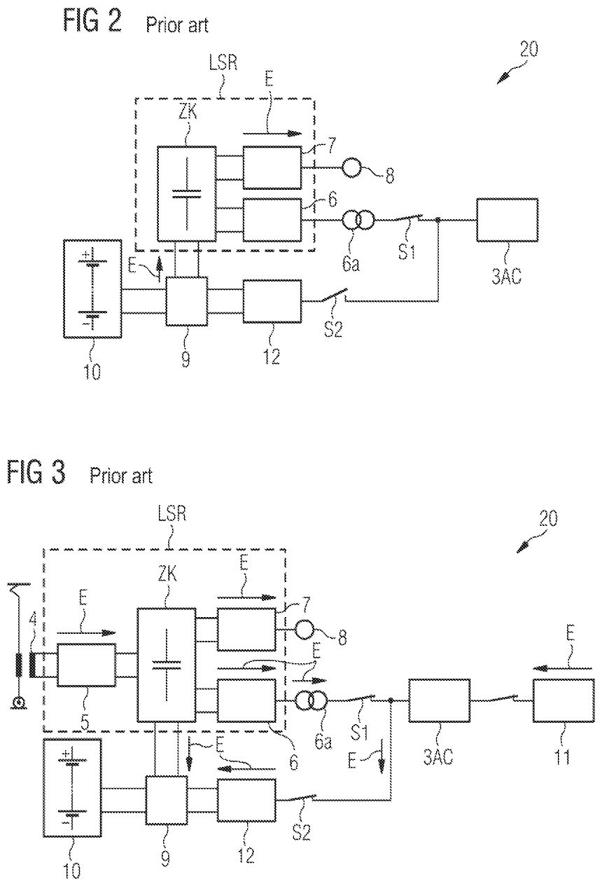

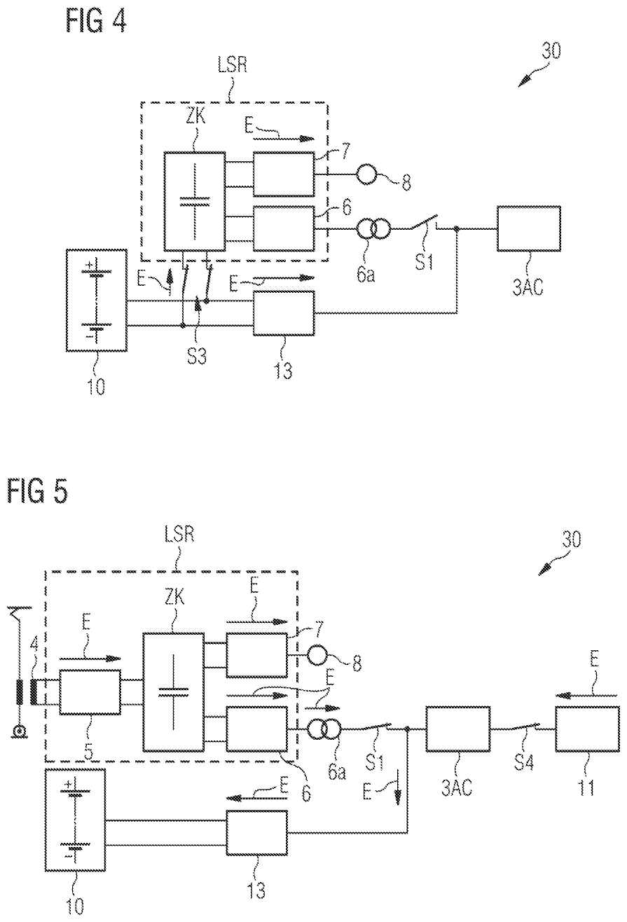

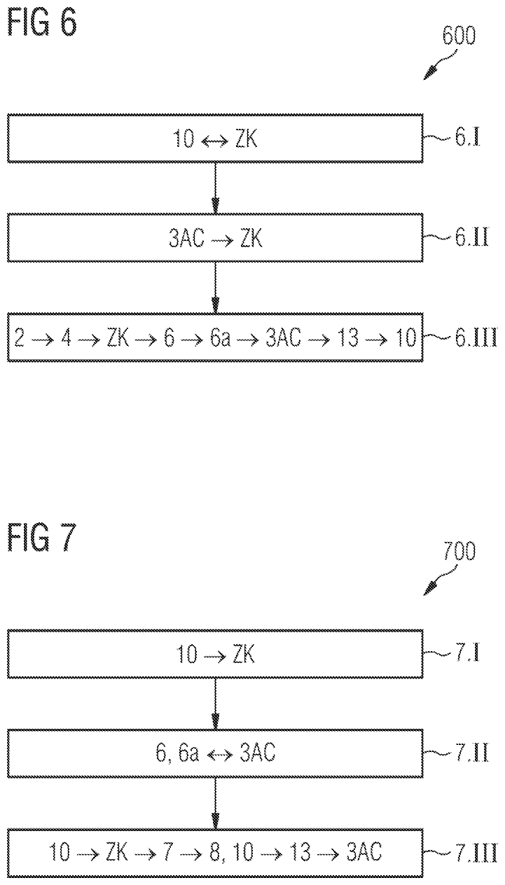

FIG. 1 shows a diagrammatic illustration of a rail vehicle with a conventional power supply device having a traction accumulator, FIG. 2 shows a diagrammatic illustration of a conventional power supply circuit of a rail vehicle having a traction accumulator during discharging of the traction accumulator, FIG. 3 shows a diagrammatic illustration of a conventional power supply circuit of a rail vehicle having a traction accumulator during charging of the traction accumulator, FIG. 4 shows a diagrammatic illustration of a power supply circuit having a traction accumulator according to an exemplary embodiment of the invention during discharging of the traction accumulator, FIG. 5 shows a diagrammatic illustration of a power supply circuit having a traction accumulator according to an exemplary embodiment of the invention during charging of traction accumulator, FIG. 6 shows a flowchart, which illustrates a charging method according to an exemplary embodiment of the invention, FIG. 7 shows a flowchart, which illustrates a discharging method according to an exemplary embodiment of the invention.

FIG. 1 shows a diagrammatic illustration of an electrified rail vehicle 1 having a traction battery 10. The electrified rail vehicle 1 comprises a pantograph 2, which is electrically connected to a main transformer 4 via a circuit breaker 3, for supply with electrical energy from the AC voltage railway power network. The main transformer 4 transforms the high voltage of the AC voltage railway power network into a lower AC voltage, which is then converted by means of a four-quadrant chopper 5 into an intermediate circuit DC voltage of approximately 2 to 4 kV for a traction intermediate circuit ZK. The traction units 8, which are operated with three-phase current with an electrical voltage of 6 kV for example, are supplied with three-phase current via pulse-controlled inverters 7 by the traction intermediate circuit ZK. Furthermore, there is also a DC connection via a DC/DC converter 9 between the traction intermediate circuit ZK and the traction battery 10. The traction intermediate circuit ZK is also electrically connected to a three-phase on-board electrical system (not shown) via a standard auxiliary converter (not shown).

FIG. 2 shows a schematic illustration of a conventional power supply circuit 20 of a rail vehicle having a traction accumulator 10 during discharging of the traction accumulator 10.

The power supply circuit 20 has a traction accumulator 10, a locomotive converter LSR, amongst other things having a traction intermediate circuit ZK, a three-phase on-board electrical system 3AC and also a DC/DC converter 9. The locomotive converter LSR also has, in addition to the traction intermediate circuit ZK, a pulse-controlled inverter 7 for converting the direct current of the traction intermediate circuit ZK into three-phase current for traction units 8 of the rail vehicle. Furthermore, the locomotive converter LSR also comprises an auxiliary converter 6, with which the direct current of the traction intermediate circuit ZK is converted into three-phase current for the three-phase on-board electrical system 3AC. Part of the power supply circuit 20 is also an auxiliary transformer 6a, which performs voltage transformation to form low electrical voltages of the three-phase on-board electrical system 3AC. A switch unit S1 between the on-board electrical system 3AC and an auxiliary transformer 6a allows connection of the on-board electrical system 3AC to the traction intermediate circuit ZK, and disconnection therefrom. The abovementioned DC/DC converter 9 is connected between the traction accumulator 10 and the locomotive converter LSR. The DC/DC converter 9 converts a DC voltage of the traction accumulator 10 of approximately 1 kV into a higher DC voltage of 4 kV of the traction intermediate circuit ZK. On account of the low load, the three-phase on-board electrical system 3AC is supplied with current via a current path via the auxiliary converter 6 and the auxiliary transformer 6a with a low degree of efficiency during battery operation, so that the range of the rail vehicle in question is reduced. Part of the conventional power supply device 20 is also a unidirectional charger 12, which is electrically connected to the DC/DC converter 9 and is electrically connected to the three-phase on-board electrical system 3AC via a switch unit S2. If the traction accumulator 10 is intended to be charged, the charger 12 is electrically connected to the three-phase on-board electrical system 3AC, as illustrated in detail in FIG. 3. However, during discharging operation illustrated in FIG. 2, the charger remains inactive and is electrically disconnected from the three-phase on-board electrical system 3AC. Arrows, which are labeled with reference sign “E” and represent the direction of energy flow, are depicted in FIGS. 2 to 5.

FIG. 3 shows a diagrammatic illustration of a conventional power supply circuit 20 having a traction accumulator 10 during charging of the traction accumulator 10.

During charging operation, the traction accumulator 10 is electrically charged either via a current path from the railway power network via the traction intermediate circuit ZK and via the DC/DC converter 9 or instead via a current path from an external feed 11 via the three-phase on-board electrical system 3AC and the charger 12. The three-phase on-board electrical system 3AC can be electrically connected to an external feed 11. An external feed 11 of this kind is used for example in a railway depot and is performed with the electrical voltage of the three-phase on-board electrical system 3AC. If, instead, power is supplied via the railway power network, for example via an overhead line, the railway current is initially transformed down by means of a main transformer 4 and then converted into direct current for the traction intermediate circuit ZK via a four-quadrant chopper 5 and is converted into direct current with a low electrical voltage of 1 kV by means of the DC/DC converter 9. In the case of external feeding, the charging current is transmitted to the traction accumulator 10 via the three-phase on-board electrical system 3AC, with the switch of the switch unit S2 between the three-phase on-board electrical system 3AC and the charger 12 closed, by means of the charger 12 and the DC/DC converter 9.

FIG. 4 shows a diagrammatic illustration of a power supply circuit 30 having a traction accumulator 10 according to an exemplary embodiment of the invention during discharging of the traction accumulator 10. The power supply circuit 30 has a traction accumulator 10, a locomotive converter LSR having a traction intermediate circuit ZK, a pulse-controlled inverter 7 and an auxiliary converter 6, a three-phase on-board electrical system 3AC and a bidirectional charger 13. The bidirectional charger 13 is connected between the traction accumulator 10 and the three-phase on-board electrical system 3AC. Furthermore, the traction accumulator 10 is directly electrically connected to the traction intermediate circuit ZK via a DC link. The DC link is formed by means of a switch unit S3, which establishes an electrical connection between the traction accumulator 10 and the traction intermediate circuit ZK during discharging operation. In this way, the traction intermediate circuit ZK is directly supplied with direct current from the traction accumulator 10 during discharging operation.

For a traction accumulator 10 with a low requirement for charging power, it is sufficient to supply power to the traction unit 8 directly from the dynamic electrical voltage of the traction accumulator 10 via the locomotive converter LSR, that is to say a traction intermediate circuit ZK comprised by the locomotive converter and an inverter 7 contained therein, and thus to avoid a DC/DC converter (see for example the DC/DC converter 9 in the conventional arrangement in FIG. 2 and FIG. 3) in the discharge path. The three-phase on-board electrical system 3AC can likewise be supplied with electrical energy E from the traction accumulator 10 via the bidirectional charger 13. In order to improve the degree of efficiency and thus the range during battery operation, the auxiliary converter 6 is decoupled from the three-phase on-board electrical system 3AC during discharging operation. The switch of a switch unit S1 between the auxiliary transformer 6a and the three-phase on-board electrical system 3AC is open during discharging operation, that is to say the electrical connection between the auxiliary converter 6 and the three-phase on-board electrical system 3AC is interrupted. Power is supplied to the three-phase on-board electrical system 3AC directly with a high degree of efficiency via the bidirectional charger 3AC.

FIG. 5 shows a diagrammatic illustration of the power supply circuit 30 shown in FIG. 4 during charging operation. During charging operation, the traction accumulator 10 is electrically disconnected from the traction intermediate circuit ZK by opening the switch of the switch unit S3 (not shown in FIG. 5) between the two abovementioned components 10, ZK and instead is electrically coupled to the three-phase on-board electrical system 3AC via the bidirectional charger 13. The three-phase on-board electrical system 3AC can be electrically connected to an external feed 11 via a switch unit S4. An external feed 11 of this kind can be realized, for example, in a railway depot with the electrical voltage of the three-phase on-board electrical system 3AC. If, instead, power is supplied via the railway power network, for example via an overhead line, the railway current is initially transformed down by means of a main transformer 4 and then converted into direct current for the traction intermediate circuit ZK by a four-quadrant chopper 5 and is then converted into on-board electrical system three-phase current by means of the auxiliary converter 6 and an auxiliary transformer 6a and converted into direct current by the bidirectional charger 13 and supplied to the traction accumulator 10 as direct current. During charging operation, there is no direct electrical or galvanic connection between the traction battery 10 and the traction intermediate circuit ZK.

FIG. 6 shows a flowchart 600, which illustrates a charging method for charging a traction battery 10 of a rail vehicle 1 according to an exemplary embodiment of the invention. During charging operation, electrical decoupling between a traction battery 10 and a traction intermediate circuit ZK of a power supply device 30 is achieved in step 6.I. For this purpose, a switch of a switch unit S3 between the traction battery 10 and the traction intermediate circuit ZK is opened, so that a DC link between the traction battery 10 and the traction intermediate circuit ZK is interrupted. In step 6.II, a three-phase on-board electrical system 3AC of the rail vehicle 1 is electrically connected to the traction intermediate circuit ZK via an auxiliary converter 6. For this purpose, a switch of a switch unit S1 between an auxiliary transformer 6a and the auxiliary converter 6 is closed and the switch unit S1 is therefore switched on. In step 6. III, railway current is drawn via the pantograph 2 of the rail vehicle 1. The railway current is converted into direct current via a main transformer 4 for the traction intermediate circuit ZK and on-board electrical system three-phase current via the auxiliary converter 6 and the auxiliary transformer 6A. The on-board electrical system three-phase current is converted into direct current via a bidirectional charger 13 and transmitted to the traction battery 10.

FIG. 7 shows a flowchart 700, which illustrates a discharging method for discharging a traction battery 10 of a rail vehicle 1 according to an exemplary embodiment of the invention. In step 7. I, the traction battery 10 is electrically connected to the traction intermediate circuit ZK. For this purpose, a switch S3 between the traction battery 10 and the traction intermediate circuit ZK is closed, that is to say switched on, so that a DC link between the traction battery 10 and the traction intermediate circuit ZK is established. In step 7. II, an auxiliary converter 6 of a locomotive converter LRS, which comprises the traction intermediate circuit ZK amongst other things, is electrically disconnected from the three-phase on-board electrical system 3AC. For this purpose, a switch S1 between the three-phase on-board electrical system 3AC and an auxiliary transformer 6a and the auxiliary converter 6 is opened, that is to say switched off. In step 7.III, direct current is then transmitted from the traction battery 10 to the traction intermediate circuit ZK via the DC link and there converted into three-phase current by a pulse-controlled inverter 7 for operation of a traction unit 8. Additionally, the direct current of the traction battery 10 is also converted, via the bidirectional charger 13, into on-board electrical system three-phase current and provided to the on-board three-phase electrical system 3AC.

Finally, it is noted once again that the above-described methods and devices are merely preferred exemplary embodiments of the invention and that the invention can be varied by a person skilled in the art without departing from the scope of the invention, to the extent that it is specified by the claims. For the sake of completeness, it is also noted that the use of the indefinite article “a” or “an” does not preclude the features in question also being present in a plurality. Likewise, the term “unit” does not preclude the latter from consisting of a plurality of components that may also be distributed spatially, if appropriate.

1-14. (canceled)

15. A power supply device for a rail vehicle, comprising:
a traction accumulator;
a traction intermediate circuit, which is operated with an electrical voltage of 2 to 4 kV during network operation;
an on-board electrical system;
an auxiliary transformer between said traction intermediate circuit and said on-board electrical system;
a bidirectional charger connected between said traction accumulator and said on-board electrical system;
a first switch unit between said traction accumulator and said traction intermediate circuit for switching over between a charging operation and a discharging operation of said traction accumulator;
a second switch unit between said on-board electrical system and said traction intermediate circuit, said second switch unit being configured to switch off for the discharging operation and to switch on for the charging operation by way of an external railway power supply; and
an auxiliary converter between said traction intermediate circuit and said on-board electrical system, said auxiliary converter to be electrically connected to said on-board electrical system via said second switch unit.

16. The power supply device according to claim 15, wherein:
said on-board electrical system is a three-phase on-board electrical system; and
said bidirectional charger comprises a current/voltage converting unit for current/voltage conversion between a DC voltage of said traction accumulator and a polyphase voltage of said on-board electrical system.

17. The power supply device according to claim 15, wherein said on-board electrical system comprises a feed interface for an on-board electrical system external feed.

18. The power supply device according to claim 15, further comprising a control unit for a closed-loop control of a charging power of said bidirectional charger to a remaining power reserve in said on-board electrical system during the charging operation.

19. The power supply device according to claim 15, wherein said traction accumulator is directly electrically connected to said traction intermediate circuit via said first switch unit during the discharging operation.

20. A method of supplying power, the method comprising:
interconnecting a bidirectional charger between a traction accumulator and an on-board electrical system of a rail vehicle;
interconnecting an auxiliary transformer between the traction intermediate circuit, which is operated with an electrical voltage of 2 to 4 kV during network operation, and the on-board electrical system;
providing a first switch unit between the traction accumulator and a traction intermediate circuit of the rail vehicle for switching over between a charging operation and a discharging operation of the traction accumulator;
providing a second switch unit between the on-board electrical system and the traction intermediate circuit, wherein the second switch unit is configured to switch off for discharging operation and to switch on for a charging operation by an external railway power supply; and
providing an auxiliary converter between the traction intermediate circuit and the on-board electrical system, wherein the auxiliary converter is configured to be electrically connected to the on-board electrical system via the second switch unit.

21. A method for discharging a traction accumulator in a rail vehicle, the method comprising:
providing the power supply device according to claim 15;
electrically connecting the traction accumulator to the traction intermediate circuit of the rail vehicle by switching on a switch of the first switch unit;
decoupling the traction intermediate circuit from the on-board electrical system via a switch of the second switch unit;
transmitting electrical energy of the traction accumulator to a traction unit of the rail vehicle via the traction intermediate circuit; and
transmitting electrical energy of the traction accumulator to the on-board electrical system of the rail vehicle via the bidirectional charger.

22. The method according to claim 21, which comprises electrically connecting the traction intermediate circuit to the on-board electrical system via the switch of the second switch unit.

23. A method for charging a traction accumulator in a rail vehicle, the method comprising:
providing the power supply device according to claim 15;
charging a traction accumulator n the traction accumulator is charged via a series circuit comprising the on-board electrical system, the bidirectional charger and the traction accumulator.

24. The method according to claim 23, which comprises charging the traction accumulator via an external railway power supply, which is electrically coupled to a series circuit formed by the on-board electrical system, the bidirectional charger and the traction accumulator via the traction intermediate circuit and a second switch unit between the on-board electrical system and the traction intermediate circuit.

25. A rail vehicle, comprising:
a railway power network supply unit;
a traction unit;
an auxiliary unit to be supplied with electric current via an on-board electrical system; and
a power supply device according to claim 15 for supplying electric current to the traction unit and the auxiliary unit.
